(19) United States
(12) Patent Application Publication
(10) Pub. No.: US 2015/0077036 A1
(43) Pub. Date: Mar. 19, 2015

(54) WIRELESS POWER DISTRIBUTION SYSTEM FOR MILITARY APPLICATIONS

(71) Applicant: DvineWave Inc., San Ramon, CA (US)

(72) Inventors: Michael A. Leabman, San Ramon, CA (US); Gregory Scott Brewer, Livermore, CA (US)

(73) Assignee: DvineWave Inc., San Ramon, CA (US)

(21) Appl. No.: 14/026,747

(22) Filed: Sep. 13, 2013

(51) Int. Cl. H02J 7/02; H01F 38/14; B60L 11/18; H02J 5/00

(52) U.S. Cl. CPC H02J 7/025; H02J 5/005; H01F 38/14; B60L 11/1811
USPC 320/101; 320/108

(57) ABSTRACT

A wireless power distribution system for military applications is disclosed. The system includes a wireless power transmitter coupled with a power source. The transmitter may form pockets of energy using controlled radio frequencies. Electrical equipment coupled with an electronic receiver may utilize pockets of energy formed by the transmitter to charge or power the electrical equipment. The transmitter coupled with a power source may be used in a fixed position or may be carried in a vehicle for portability.

### CROSS-REFERENCES TO RELATED APPLICATIONS

The present disclosure is related to U.S. Non-Provisional patent application Ser. No. 13/891,430 filed May 10, 2013, entitled “Methodology For Pocket-forming”; Ser. No. 13/925,469 filed Jun. 24, 2013, entitled “Methodology for Multiple Pocket-Forming”; Ser. No. 13/946,082 filed Jul. 19, 2013, entitled “Method for 3 Dimensional Pocket-forming”; Ser. No. 13/891,399 filed May 10, 2013, entitled “Receivers for Wireless Power Transmission” and Ser. No. 13/891,445 filed May 10, 2013, entitled “Transmitters For Wireless Power Transmission”, the entire contents of which are incorporated herein by these references.

### FIELD OF INVENTION

The present disclosure relates to electrical power distribution, and more particularly to wireless power distribution on military expeditions and camps.

### BACKGROUND OF THE INVENTION

In military situations, electrical energy becomes indispensable to support the front line and enable defense personnel to live, work, train and deploy at home and overseas or remote locations, Many electrical devices used on the field may require a source of power and thus, batteries are carried, and mobile power generators are transported and installed in remote locations. Power generators may include: mobile diesel generators, solar photovoltaic arrays, wind turbines or any source that serves as an electrical power source. Usually when a military expedition arrives in a new location, installation of a power distribution system is necessary, which usually involves complex, tedious and time consuming wired connections. Military camps or settlements may also be required to move from one location to another frequently, which may incur in continuously installing and uninstalling the power distribution system. Installing and uninstalling the power distribution system may be a tedious process.

When engaged in combat, soldiers may carry equipment such as radios, night vision goggles, rifle scopes and/or other military equipment that may require an electrical power source. Soldiers carry batteries as a power source for these devices; however, carrying batteries adds additional weight to the equipment each soldier carries and switching old used batteries for new ones under the stress of battle may be troubling and impractical in some situations.

Thus, a need exists for an electrical power source that addresses the aforementioned issues.

### SUMMARY OF THE INVENTION

The present disclosure is a power distribution system for military applications. The power distribution system includes a wireless transmitter coupled with a power generator source such as a mobile diesel generator, a solar photovoltaic array, wind turbines or any reliable power source or combination thereof. The wireless power transmitter uses energy from the power generator source and creates pockets of energy at different determined locations. Electrical devices may be coupled with wireless receiver components that may use the pockets of energy to charge or power the electrical devices. The power distribution system may avoid tedious wired connections and may be more easily installed and uninstalled.

A method for a wireless power distribution system for military applications, comprising the steps of: transmitting controlled radio frequency waves from a pocket-forming transmitter to converge pockets of energy in 3-d space to form the wireless power distribution system; connecting a power source to the transmitter; and capturing the pockets of energy by a receiver to charge or power an electronic device connected to the receiver in the wireless power distribution system.

A method for a wireless power distribution system for military applications comprising the step of transmitting pockets of energy from a pocket-forming transmitter including a housing suitable for battlefield use, at least two antenna elements, at least one RF integrated circuit, at least one digital signal processor having security logic and a communication component and the step of receiving the pockets of energy by a receiver connected to an electronic device having a battery including a housing for battlefield use, at least one antenna element, one rectifier, one power converter, a security code and a communication component to establish communication with the pocket-forming transmitter for continuing to receive the pockets of energy from the pocket-forming transmitter while the electronic device is mobile and within a predetermined range of the transmitter with the security code of the receiver recognized by the security logic of the transmitter.

In another embodiment the wireless transmitter may be mounted with the power source over a vehicle in order to provide mobility. The vehicle may accompany soldiers into the battlefield and provide Wireless energy to any electrical devices the soldiers use, which may in turn prevent the need to use replaceable batteries.

### BRIEF DESCRIPTION OF THE DRAWINGS

Embodiments of the present disclosure are described by way of example with reference to the accompanying figures, which are schematic and are not intended to be drawn to scale. Unless indicated as representing prior art, the figures represent aspects of the present disclosure.

FIG. 1 illustrates wireless power transmission using pocket-forming, according to an embodiment.

FIG. 2 illustrates a component level embodiment for a transmitter, according to an embodiment.

FIG. 3 illustrates a component level embodiment for a receiver, according to an embodiment.

FIG. 4 illustrates a military camp with a wireless power distribution system, according to an embodiment.

FIG. 5 illustrates a mobile power source for battlefield support, according to an embodiment.

FIG. 6 illustrates a mobile power source for remote control vehicles, according to an embodiment.

### DETAILED DESCRIPTION OF THE DRAWINGS

### Definitions

“Packet-forming” may refer to generating two or more RF waves Which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain. adjusted with respect to other RF signals, substantially all of which pass through one or more RF antenna such that focused RF signals are directed to a target.

“Receiver” may refer to a device which may include at least one antenna, at least one rectifying circuit and at least one power converter for powering or charging an electronic device using RF waves.

“Adaptive pocket-forming” may refer to dynamically adjusting pocket-forming to regulate power on one or more targeted receivers.

### DESCRIPTION OF THE DRAWINGS

In the following detailed description, reference is made to the accompanying drawings, which form a part hereof. In the drawings, which may not be to scale or to proportion, similar symbols typically identify similar components, unless context dictates otherwise. The illustrative embodiments described in the detailed description, drawings and claims, are not meant to be limiting, Other embodiments may be used and/or and other changes may be made without departing from the spirit or scope of the present disclosure.

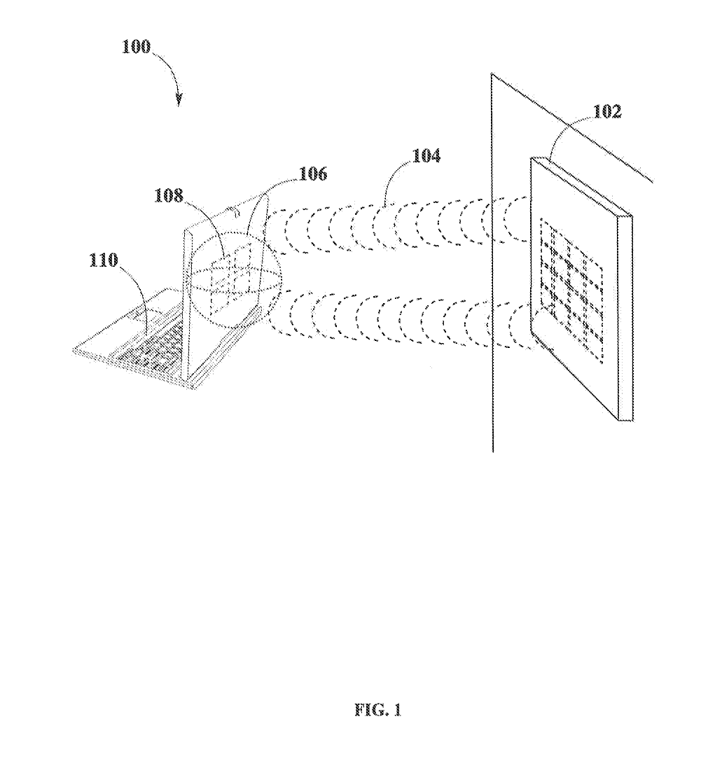

FIG. 1 illustrates wireless power transmission 100 using pocket-forming. A transmitter 102 may transmit controlled Radio Frequency (RF) waves 104 which may converge in 3-d space. These RF waves may be controlled through phase and/or relative amplitude adjustments to form constructive and destructive interference patterns (pocket-forming). Pockets of energy 106 may form at constructive interference patterns and can be 3-dimensional in shape whereas null-spaces may be generated at destructive interference patterns. A receiver 108 may then utilize pockets of energy produced by pocket-forming for charging or powering an electronic device, for example a laptop computer 110 and thus effectively providing wireless power transmission 100. In some embodiments, there can be multiple transmitters 102 and/or multiple receivers 108 for powering various electronic devices, for example smartphones, tablets, music players, toys and others at the same time. In other embodiments, adaptive pocket-forming may be used to regulate power on electronic devices.

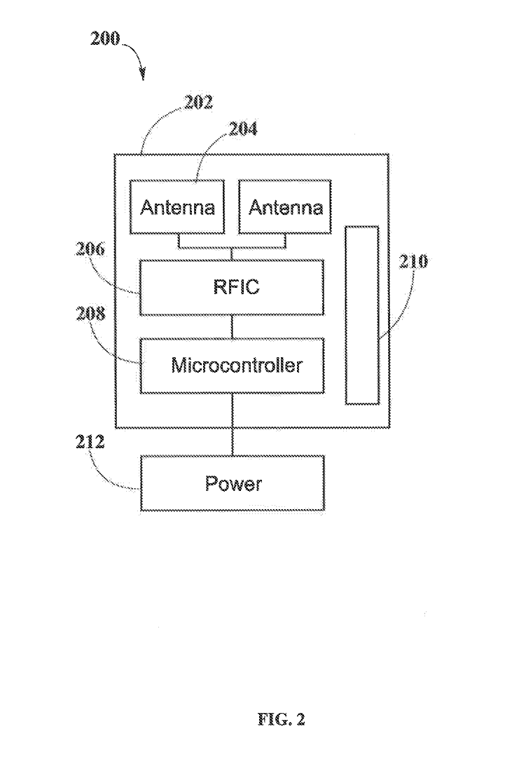

FIG. 2 illustrates a component level embodiment for a transmitter 200 which may be utilized to provide wireless power transmission 100 as described in FIG. 1. Transmitter 200 may include a housing 202 where at least two or more antenna elements 204, at least one RF integrated circuit (RFIC 206). at least one digital signal processor (DSP) or micro-controller 208, and one optional communications component 210 may be included. Housing 202 can be made of any suitable material which may allow for signal or wave transmission and/or reception, for example plastic or hard rubber, Antenna elements 204 may include suitable antenna types for operating in frequency bands such as 900 MHz, 2.5 GHz or 5.8 GHz as these frequency bands conform to Federal Communications Commission (FCC) regulations part 18 (Industrial, Scientific and Medical equipment). Antenna elements 204 may include vertical or horizontal polarization, right hand or left hand polarization, elliptical polarization, or other suitable polarizations as well as suitable polarization combinations. Suitable antenna types may include, for example, patch antennas with heights from about ⅛ inches to about 6 inch and widths from about ⅛ inches to about 6 inch. Other antenna elements 204 types can be used, for example meta-materials, dipole antennas among others. RFIC 206 may include a proprietary Chip for adjusting phases and/or relative magnitudes of RF signals which may serve as inputs for antenna elements 204 for controlling pocket-forming. These RF signals may be produced using an external power supply 212 and a local oscillator chip (not shown) using a suitable piezoelectric material. Micro-controller 208 may then process information send by a receiver through its own antenna elements for determining optimum times and locations for pocket-forming. In some embodiments, the foregoing may be achieved through communications component 210. Communications component 210 may be based on standard wireless communication protocols which may include Bluetooth, Wi-Fi or ZigBee. In addition, communications component 210 may be used to transfer other information such as an identifier for the device or user, battery level, location or other such information. Other communications component 210 may be possible which may include radar, infrared cameras or sound devices for sonic triangulation for determining the device's position.

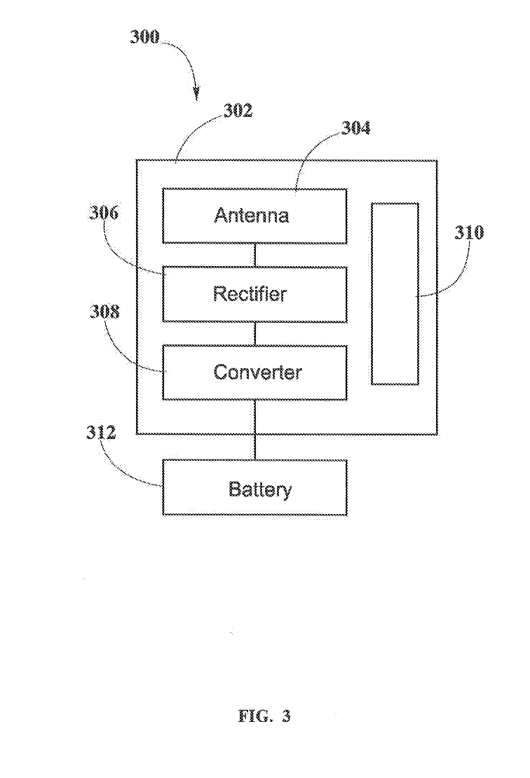

FIG. 3 illustrates a component level embodiment for a receiver 300 which can be used for powering or charging an electronic device as exemplified in wireless power transmission 100. Receiver 300 may include a housing 302 where at least one antenna element 304, one rectifier 306, one power converter 308 and an optional communications component 310 may be included, Housing 302 can be made of any suitable material which may allow for signal or wave transmission and/or reception, for example plastic or hard rubber. Housing 302 may be an external hardware that may be added to different electronic equipment, for example in the form of cases, or can be embedded within electronic equipment as well. Antenna element 304 may include suitable antenna types for operating in frequency bands similar to the bands described for transmitter 200 from FIG. 2. Antenna element 304 may include vertical or horizontal polarization, right hand or left hand polarization, elliptical polarization, or other suitable polarizations as well as suitable polarization combinations. Using multiple polarizations can be beneficial in devices where there may not be a preferred orientation during usage or whose orientation may vary continuously through time, for example a smartphone or portable gaming system. On the contrary, for devices with well-defined orientations, for example a two-handed video game controller, there might be a preferred polarization for antennas which may dictate a ratio for the number of antennas of a given polarization. Suitable antenna types may include patch antennas with heights from about ⅛ inches to about 6 inch and widths from about ⅛ inches to about 6 inch. Patch antennas may have the advantage that polarization may depend on connectivity, i.e. depending on which side the patch is fed, the polarization may change. This may further prove advantageous as a receiver, such as receiver 300, may dynamically modify its antenna polarization to optimize wireless power transmission. Rectifier 306 may include diodes or resistors, inductors or capacitors to rectify the alternating current (AC) voltage generated by antenna element 304 to direct current (DC) voltage. Rectifier 306 may be placed as close as is technically possible to antenna element 304 to minimize losses. After rectifying AC voltage, DC voltage may be regulated using power converter 308. Power converter 308 can be a DC-DC converter which may help provide a constant voltage output, regardless of input, to an electronic device, or as in this embodiment to a battery 312. Typical voltage outputs can be from about 5 volts to about 10 volts. Lastly, communications component 310, similar to that of transmitter 200 from FIG. 2, may be included in receiver 300 to communicate with a transmitter 200 or to other electronic equipment,

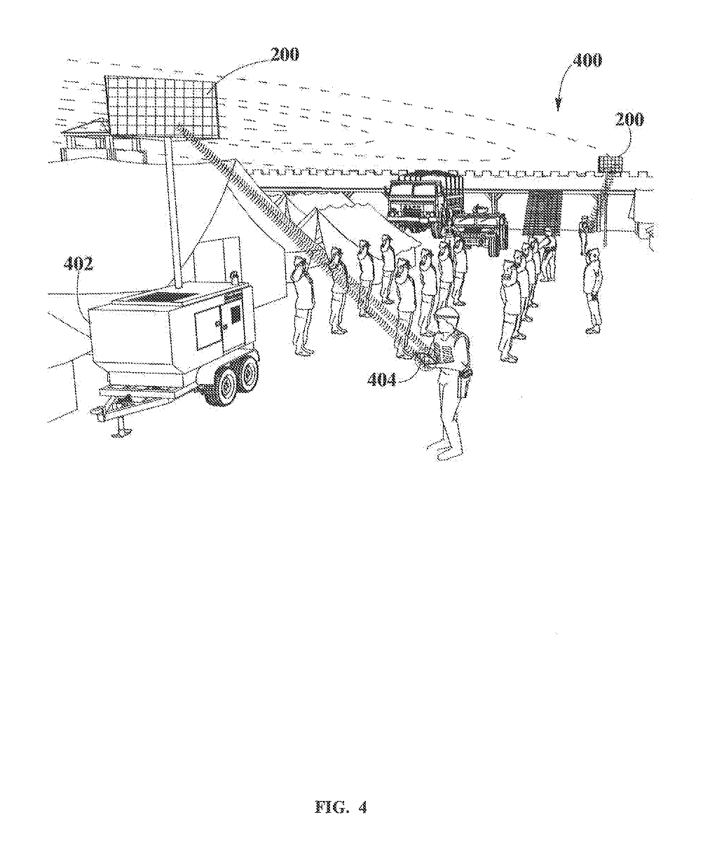

FIG. 4 is an example embodiment of a power distribution system 400 in a military camp where troops may be settled in remote locations. power distribution system 400 may include a mobile power generator 402, which may serve to power electrical equipment, Mobile power generator 402 may be a mobile diesel generator as illustrated in FIG. 4 or other sources such as solar photovoltaic arrays, wind turbines or any reliable power source or combination thereof Coupled with mobile power generator 402 may be a transmitter 200, which may enable wireless power transmission 100. Transmitter 200 may use mobile power generator 402 as a power source to form pockets of energy 106. Pockets of energy 106 may form at constructive interference patterns and can be 3-dimensional in shape whereas mill-spaces may be generated at destructive interference patterns. Electrical devices 404 such as radios, laptops or any devices requiring a power input may be coupled with a receiver 300, Receiver 300 may then utilize pockets of energy 106 produced by pocket-Twining for charging or powering electrical devices 404.

Transmitter 200 may form pockets of energy 106 covering a range from about a few feet to hundreds of feet depending on the size of the antenna array. For the foregoing application, about 30 to about 60 feet may suffice. Additional transmitters 200 may be used to extend the distance in a power distribution system. A central transmitter 200 coupled with mobile power generator 402 may serve as a central distribution center while additional transmitters 200 may be placed at a distance and retransmit energy received from the central transmitter to reach greater distances. Each transmitter 200 size may be relative to the desired transmission distance.

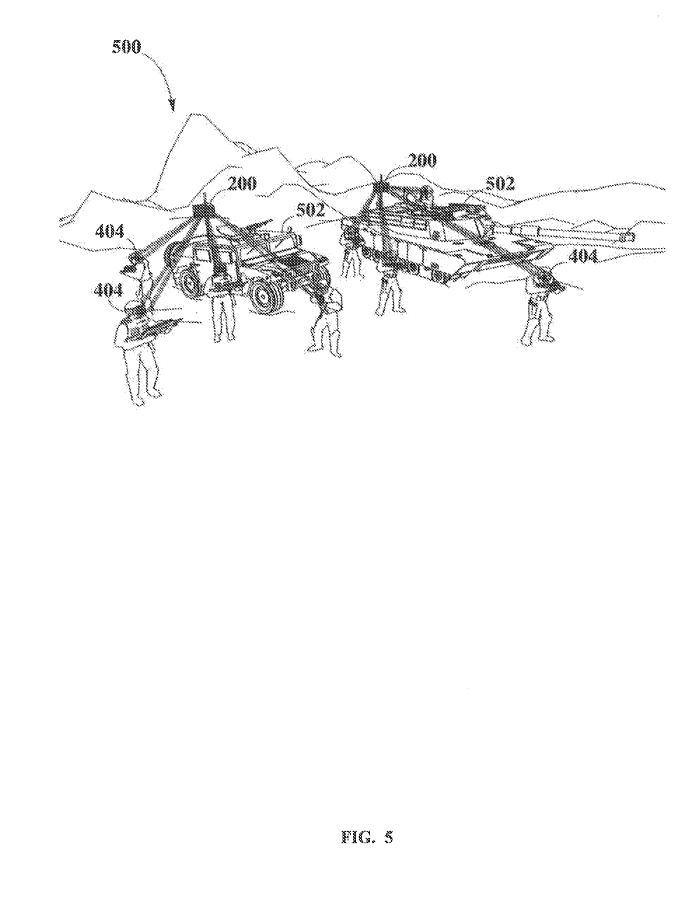

FIG. 5 is another example embodiment of a power distribution system 500. A transmitter 200 coupled with a mobile power generator 402 may be mounted over a military vehicle 502 in order to add mobility. Military vehicle 502 may be any vehicle with enough robustness and ruggedness for battlefield applications such as a high mobility multipurpose wheeled vehicle (HMMWV/Humvee), armored trucks, tanks or any vehicle capable of carrying transmitter 200 coupled with mobile power generator 402. Military vehicle 502 may accompany soldiers into the battlefield and serve as a power source for electrical devices 404 carried by soldiers. Electrical devices 404 carried by soldiers may be coupled with receivers 300 in order to receive energy from transmitter 200.

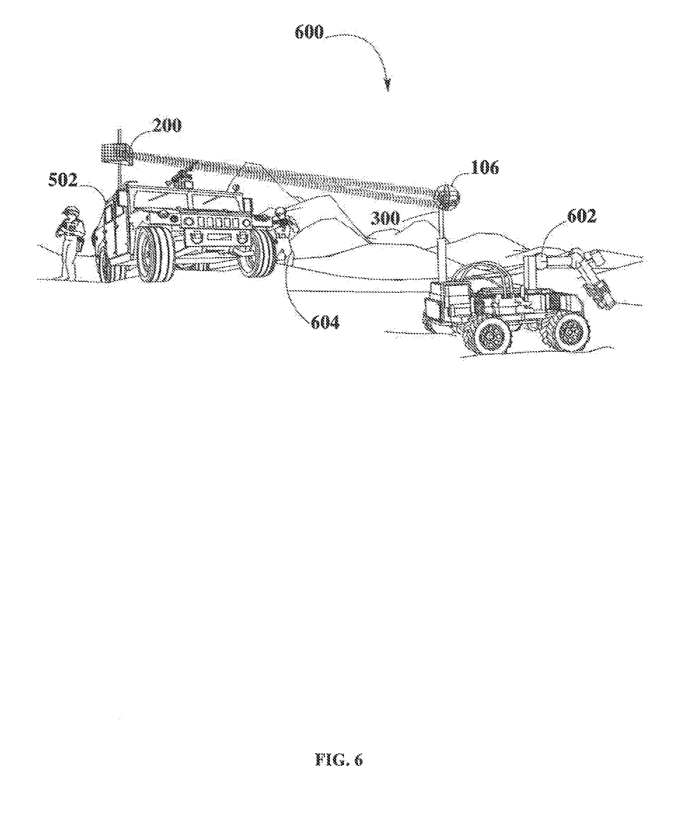

FIG. 6 is another embodiment of power distribution system 600 where remote controlled vehicles 602 designed for espionage, detecting mines or disabling bombs may be powered wirelessly. In this embodiment, remote control and power may be critical factors to prevent exposure or harm to human soldiers 604. Remote controlled vehicle 602 may be coupled with a receiver 300. A transmitter 200 coupled with a mobile power generator 402 may form pockets of energy 106 at constructive interference patterns that may be 3-dimensional in shape whereas null-spaces may be generated at destructive interference patterns. A receiver 300 may then utilize pockets of energy 106 produced by pocket-forming for charging or powering remote controlled vehicle 602. While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

Having thus described the invention, I claim:

1. A method for a wireless power distribution system for military applications, comprising the steps of:
transmitting controlled radio frequency waves from a pocket-forming transmitter to converge pockets of energy in 3-d space to form the wireless power distribution system. for military applications;
connecting a power source to the transmitter; and
capturing the pockets of energy by a receiver embedded into or connected to military electronic devices for charging or powering the electronic devices within a predetermined range of the wireless power distribution system.

2. The method for a wireless power distribution system for military applications of claim 1, wherein the power source is a mobile diesel generator, a mobile gasoline generator, solar panels, wind turbines or other mobile power source.

3. The method for a wireless power distribution system for military applications of claim 2, wherein the transmitter includes a housing suitable for field use, at least two antenna elements, at least one RF integrated circuit, at least one digital signal processor having security logic and a communication component.

4. The method for a wireless power distribution system for military applications of claim 3, wherein the receiver includes a housing, at least one antenna element, one rectifier, one power converter, a security code and a communication component to establish communication with the transmitter for continuing to receive power from the transmitter through pocket-forming when the electronic device is mobile within a predetermined range of the transmitter and the security code is recognized by the security logic of the transmitter.

5. The method for a wireless power distribution system for military applications of claim. 1, wherein the pocket-forming transmitter includes a housing suitable for battlefield use, at least two antenna elements, at least one RF integrated circuit, at least one digital signal processor having security logic and a communication component and Wherein the receiver connected to each electronic device having a battery includes a housing for battlefield use, at least one antenna element, one rectifier, one power converter, a security code and a communication component to establish communication with the pocket-forming transmitter for continuing to receive the pockets of energy from the pocket-forming transmitter while the electronic device is mobile and within the predetermined range of the transmitter with the security code of the receiver recognized by the security logic of the transmitter.

6. The method for a wireless power distribution system for military applications of claim 2, further including the step of extending the transmission distance of the pocket-forming transmitter by mounting the pocket-forming transmitter a predetermined height about a top surface of the mobile generator coupled to a pole of the predetermined height.

7. The method for a wireless power distribution system for military applications of claim 1, further including the step of re-transmitting the power from the pocket-forming transmitter to at least one secondary pocket-forming transmitter to extend the distance in the power distribution system.

8. The method for a wireless power distribution system for military applications of claim 4, wherein the receiver communicates to the transmitter through short RF signals sent through antenna elements within the receiver.

9. The method for a wireless power distribution system for military applications of claim 6, wherein the short RF signals are standard wireless communication protocols including Bluetooth, Wi-Fi, ZigBee or FM radio.

10. The method for a wireless power distribution system for military applications of claim 4, further includes the step of utilizing adaptive pocket-forming to regulate the pockets of energy transmitted by the central transmitter to power the electronic device and to re-transmitting power to at least one secondary transmitter for powering electronic devices out of range from the central transmitter.

11. The method for a wireless power distribution system for military applications of claim 4, further including the step of coupling a transmitter to the power source wherein the power source is a mobile generator having poles and other supports protruding above the generator a predetermined distance to extend the reach of the transmitter in the power distribution systems for charging electronic devices.

12. The method for a wireless power distribution system for military applications of claim 6, wherein the receiver captures pockets of energy from the transmitter and then is switched to the at least one secondary transmitter when in proximity to the at least one transmitter for capturing the pockets of energy to continue powering the electronic device as it moves from one location to another in the field.

13. The method for a wireless power distribution system for military applications of claim 1, wherein the receiver is embedded in a remote controlled vehicle for receiving pockets of energy from the pocket-forming transmitter to power the vehicle to prevent human exposure to bombs or other things that could cause harm to the human soldier.

14. A wireless power distribution system for military applications, comprising:
a transmitter for pocket-forming to send controlled radio frequency waves to converge into pockets of energy in 3-d space;
a mobile power source connected to the transmitter for powering the transmitter; and
a receiver for capturing the pockets of energy to charge or power an electronic device connected to the receiver.

15. The wireless power distribution system for military applications of claim 13, wherein the transmitter is a mobile transmitter mounted on the power source.

16. The wireless power distribution system for military applications of claim 13, wherein the mobile power source is a portable generator running on diesel, gas or solar power.

17. The wireless power distribution system for military applications of claim 13, further includes a secondary transmitter powered by the pocket-forming transformer for extending the range of the power distribution system.

18. The wireless power distribution system for military applications of claim 13, wherein the pocket-forming transmitter re-transmits the power it receives to a secondary receiver for powering the electronic device out of reach by the pocketing-forming transmitter.

19. The wireless power distribution system for military applications of claim 15, wherein the transmitter communicates with the receiver through short RF signals over standard wireless communication protocols including Bluetooth, Wi-Fi, ZigBee or FM radio.

20. A wireless power distribution system for military applications, comprising:
a pocket-forming transmitter for transmitting power RF waves to form pockets of energy to charge the electronic device;
a mobile power source coupled to the transmitter for powering the pocket-forming transmitter wherein the wireless transmitter is mounted with the mobile power source in a predetermined location on a vehicle in order to provide mobility and wherein the vehicle accompanies soldiers into a battlefield to provide wireless energy to any portable electrical devices used by the soldiers to prevent the need for replaceable batteries during a battle; and
a receiver connected to each electronic device for capturing the pockets of energy transmitted by the pocket-forming transmitter to charge or power the electronic devices in the battlefield.

21. The wireless power distribution system for military applications of claim 19, further including receivers embedded in night goggles for powering or charging the night goggles or other military equipment having a battery while the night goggles or military equipment are within a predetermined range of the transmitter.
